(19) United States
(12) Patent Application Publication
(10) Pub. No.: US 2022/0307881 A1
(43) Pub. Date: Sep. 29, 2022

(54) Electromagnetic Flowmeter

(71) Applicant: ABB Schweiz AG, Baden (CH)

(72) Inventor: Subhashish Dasgupta, Bangalore (IN)

(73) Assignee: ABB Schweiz AG, Baden (CH)

(21) Appl. No.: 17/841,780

(22) Filed: Jun. 16, 2022

Related U.S. Application Data
(63) Continuation of application No. PCT/IB2020/062257, filed on Dec. 19, 2020.

(30) Foreign Application Priority Data
Dec. 31, 2019 (IN) 201941054621

(51) Int. Cl. G01F 1/58; G01F 1/60

(52) U.S. Cl. CPC G01F 1/588; G01F 1/60

(57) ABSTRACT

An electromagnetic flowmeter and method for measuring a flow of a fluid through a conduit includes utilizing at least two coils, at least two electrodes, and a control circuitry. The at least two coils are electrically excited to generate a magnetic field within a flowmeter fluid space. First and second coils are placed around first and second central axes of the conduit. The at least two electrodes are arranged diametrically opposite to each other to detect an induced voltage in the flowmeter fluid space in response to the generated magnetic field. The control circuitry for measuring the induced voltage on each of the at least two electrodes provides a measure of flow of the fluid.

### CROSS-REFERENCE TO RELATED APPLICATIONS

This patent application claims priority to International Patent Application No. PCT/IB2020/062257, filed on Dec. 19, 2020, which claims priority to Indian Patent Application No. 201941054621, filed on Dec. 31, 2019, both of which are incorporated herein in their entirety by reference.

### FIELD OF THE DISCLOSURE

The present disclosure generally relates to an electromagnetic flowmeter and a method thereof for measuring a flow of a fluid through a conduit. Particularly, the present disclosure provides the electromagnetic flowmeter for detecting and quantifying a partial filling of the conduit.

### BACKGROUND OF THE INVENTION

Electromagnetic (EM) flowmeter is one of variety of methods that are available for measuring the flow of the fluid through the conduit. Principle of operation for the conventional EM flowmeter is based on a principle of Faraday's Law of Electromagnetic Induction. An electromagnetic field is applied within a flowmeter fluid space of the conduit having the flow of the fluid with a certain level of conductivity. Consequently, in response to the interaction between the applied electromagnetic field and the flow of the fluid through the conduit induces an electromotive force (EMF). The induced EMF can be measured using electrodes provided at an inner periphery/side walls of the conduit. The measured EMF is directly proportional to a flowrate of the fluid and this facilitates the measurement of the flow of the fluid through the conduit.

In the conventional EM flowmeter, when there is change in signal partial filling condition cannot be ascertained. Since the signal of the conventional EM flowmeter may also change due to a change in the flowrate. There is a need for an idea to detect partial filing and distinguish partial filing condition from changing flowrate condition.

FIG. 1A illustrates a perspective view 100a of the electromagnetic (EM) flowmeter according to a prior art. The EM flowmeter comprises an insulated pipe or a conduit 101 with at least two coils 102a, 102b that are flanking a top and bottom of the conduit 101. The at least two coils 102a, 102b are arranged diametrically opposite to each other and a first central axis 102c passing through the at least two coils 102a, 102b that connects a center 101a of the conduit 101. When the at least two coils 102a, 102b are electrically excited to generate a magnetic field within the flowmeter fluid space, in accordance with Faraday's law of electromagnetic induction, an electromotive force (EMF) is generated within the EM flowmeter fluid space. The EMF is directly proportional to the flowrate or velocity of the fluid, and can be used to estimate the flowrate.

FIG. 1B illustrates a cross sectional view 100b of the EM flowmeter according to a prior art. The EM flowmeter comprises at least two electrodes 103a, 103b that are arranged diametrically opposite to each other to detect an induced voltage in the flowmeter fluid space in response to the generated magnetic field. A central axis 103c that is passing through the at least two electrodes 103a, 103b and connects the center 101a of the conduit 101. The central axis 103c is in-line with an axis 103d that diametrically divides the conduit 101 through the center 101a of the conduit 101. The central axis 103c is perpendicular to the first central axis 102c of the conduit 101. The EMF is given by a potential difference between the at least two electrodes 103a, 103b (+V and −V), at extremes of a diameter 105 of the conduit 101, normal to a direction of the flow of the fluid 104, where the at least two electrodes are instrumented.

According to the prior art, the at least two coils 102a, 102b and the at least electrodes 103a, 103b are symmetric to the first central axis 102c of the EM flowmeter. Absolute value of at least one ratio of the measured induced voltages (+V and −V) is ‘1’ at different flowrate and under any degree of the partial filing. In other words, (+V and −V) induced voltages will be equal in magnitude due to the above-mentioned symmetry. Therefore, the degree of the partial filling cannot be detected or quantified using the conventional EM flowmeter. It is desirable, if the EM flowmeters have the ability to detect and quantify partial filing of the conduit using simplistic and cost-effective techniques.

### BRIEF SUMMARY OF THE INVENTION

Currently, there is a need for an electromagnetic (EM) flowmeter to detect and quantify the partial filing of the conduit and to measure low flowrate of the fluid with a minimal modification to components of the EM flowmeter.

In one aspect, the present disclosure mitigates, alleviates or eliminates one or more of the above-identified deficiencies and disadvantages in the prior art and solves at least the above mentioned problem.

In view of the foregoing, an embodiment herein provides a first aspect of an electromagnetic (EM) flowmeter and a second aspect of a method thereof for measuring a flow of a fluid through a conduit with a minimal modification to the EM flowmeter components.

According to a first aspect of an embodiment, an electromagnetic (EM) flowmeter is provided for measuring a flow of a fluid through a conduit, comprising: at least two coils, at least two electrodes and a control circuitry. The at least two coils are arranged on the conduit and the at least two coils are electrically excited to generate a magnetic field within a flowmeter fluid space of the conduit. A first coil of the at least two coils is placed around a first central axis of the conduit and a second coil of the at least two coils is placed around a second central axis of the conduit. The second central axis is different from the first central axis. The first central axis subtends a first predefined angle θ₁ with the second central axis.

The at least two electrodes are arranged diametrically opposite to each other to detect an induced voltage in the flowmeter fluid space in response to the generated magnetic field. The at least two electrodes are placed at a second predefined angle θ₂. The second predefined angle θ₂ is subtended at a center of the conduit between a central axis passing through the at least two electrodes and an axis that is perpendicular to the first central axis of the conduit. The control circuitry for measuring the induced voltage on each of the at least two electrodes to provide a measure of the flow of the fluid through the conduit.

According to an embodiment, the control circuitry of the EM flowmeter comprises a processing unit for determining a degree of a partial filling of the conduit based on at least one ratio between the measured induced voltages of each of the at least two electrodes. The at least one ratio is utilized to estimate the degree of the partial filling of the conduit at different flow rates by referring to a characteristic curve, based on its variation from a ratio under fully filled condition.

According to yet another embodiment, the at least one ratio is an absolute value of the measured induced voltages of each of the at least two electrodes. The degree of the partial filling of the conduit is a ratio of a height of a fluid surface from bottom of the conduit to a diameter of the conduit.

According to yet another embodiment, the absolute value of the at least one ratio under fully filled condition at the different flowrates, is predetermined by a physics-based digital twin model of the EM flowmeter. According to another embodiment, the physics-based digital twin model of the EM flowmeter is utilized for optimizing the first predefined angle θ₁ of the second coil of the at least two coils. The first predefined angle θ₁ is in the range of ±5% from the first central axis. In an exemplary embodiment, when the first predefined angle θ₁ is zero, the second predefined angle θ₂ is not equal to zero. Thus, maintaining asymmetry from a perspective of the at least two electrodes.

According to yet another embodiment, the physics-based digital twin model of the EM flowmeter is utilized for optimizing the second predefined angle θ₂ of the at least one of the at least two electrodes. The second predefined angle θ₂ is in a range of ±5% from the axis. In an exemplary embodiment, when the second predefined angle θ₂ is zero, the first predefined angle θ₁ is not equal to zero. Thus, maintaining asymmetry from a perspective of the at least two coils. The characteristic curve is generated based on the physics-based digital twin model of the EM flowmeter corresponding to the optimized first and second predefined angles (θ₁ and θ₂).

According to yet another embodiment, the processing unit is provided for checking the partial filling of the flow of the fluid through the conduit at a predetermined interval.

According to yet another embodiment, the processing unit is provided for sending an alert to a controller/user when the partial filling of the flow of the fluid through the conduit is determined below a predefined threshold.

According to a second aspect of an embodiment, the method of operating an electromagnetic (EM) flowmeter is provided for measuring a flow of a fluid through a conduit. The method comprising steps of exciting at least two coils that are arranged on the conduit to generate a magnetic field within a flowmeter fluid space of the conduit and measuring an induced voltage on each of at least two electrodes that are arranged to detect an induced voltage in the flowmeter fluid space, in response to the generated magnetic field.

According to an embodiment, a first coil of the at least two coils is placed around a first central axis of the conduit and a second coil of the at least two coils is placed around a second central axis of the conduit. The second central axis is different from the first central axis. The first central axis subtends a first predefined angle θ₁ with the second central axis. The at least two electrodes are placed at a second predefined angle θ₂ and the second predefined angle θ₂ is subtended at the center of the conduit between a central axis passing through the at least two electrodes and an axis that is perpendicular to the first central axis of the conduit.

According to another embodiment, the method further comprising a step of determining a degree of a partial filling of the conduit based on at least one ratio between the measured induced voltages of each of the at least two electrodes. The at least one ratio is utilized for estimating the degree of the partial filling of the conduit at different flow rates by referring to a characteristic curve based on variation of the ratio than the ratio under fully filled condition.

According to yet another embodiment, the at least one ratio is an absolute value of the measured induced voltages of each of the at least two electrodes. The degree of the partial filling of the conduit is a ratio of a height of a fluid surface from bottom of the conduit to a diameter of the conduit.

According to yet another embodiment, the absolute value of the at least one ratio under fully filled condition at the different flowrates, is predetermined by a physics-based digital twin model of the EM flowmeter.

According to yet another embodiment, the method further comprising a step of optimizing the first predefined angle θ₁ of the second coil of the at least two coils using the physics-based digital twin model of the EM flowmeter. The first predefined angle θ₁ is in the range of ±5% from the first central axis. In an exemplary embodiments, when the first predefined angle θ₁ is zero, the second predefined angle θ₂ is not equal to zero.

According to yet another embodiment, the method further comprising a step of optimizing the second predefined angle θ₂ of the at least one of the at least two electrodes using the physics-based digital twin model of the EM flowmeter. The second predefined angle θ₂ is in a range of ±5% from the axis. In an exemplary embodiments, when the second predefined angle θ₂ is zero, the first predefined angle θ₁ is not equal to zero. The characteristic curve is generated based on the physics-based digital twin model of the EM flowmeter corresponding to the optimized first and second predefined angles (θ₁ and θ₂).

According to yet another embodiment, the method further comprising a step of checking the partial filling of the flow of the fluid through the conduit at a predetermined interval.

According to yet another embodiment, the method further comprising a step of sending an alert to a controller or user when the partial filling of the flow of the fluid through the conduit is determined below a predefined threshold.

Effects and features of the second aspect are to a large extent analogous to those described above in connection with the first aspect. Embodiments mentioned in relation to the first aspect are largely compatible with the second aspect.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, and “the” are intended to mean that there are one or more of the elements unless the context explicitly dictates otherwise. Thus, for example, reference to “a circuitry” or “the circuitry” may include several devices, and the like. Furthermore, the words “comprising”, “including”, “containing” and similar wordings does not exclude other elements or steps.

The present disclosure will become apparent from the detailed description given below. These and other aspects of the embodiments and other objects and advantages of the present invention herein will be better appreciated and understood when considered in conjunction with the following description and the accompanying drawings. The accompanying drawings are incorporated for illustration of preferred embodiments of the present invention and are not intended to limit the scope thereof. It should be understood, however, that the following descriptions, while indicating preferred embodiments and numerous specific details thereof, are given by way of illustration and not of limitation. Different configuration changes and modifications may be made within the scope of the embodiments herein without departing from the spirit thereof, and the embodiments herein include all such modifications.

### BRIEF DESCRIPTION OF THE SEVERAL VIEWS OF THE DRAWING(S)

The detailed description is set forth with reference to the accompanying figures. In the figures, the left-most digit(s) of a reference number identifies the figure in which the reference number first appears. The use of the same reference numbers in different figures indicates similar or identical items.

FIG. 1A illustrates a perspective view of an electromagnetic flowmeter according to a prior art;

FIG. 1B illustrates a cross-sectional view of the electromagnetic flowmeter of FIG. 1A according to a prior art;

FIG. 2A illustrates a perspective view of an electromagnetic flowmeter according to an embodiment herein;

FIG. 2B illustrates a cross-sectional view of the electromagnetic flowmeter of FIG. 2A according to an embodiment herein;

FIG. 3 illustrates an exemplary arrangement of an electromagnetic flowmeter according to an embodiment herein;

FIG. 4 is a flow diagram illustrating a method for measuring a flow of a fluid through a conduit using an electromagnetic flowmeter according to an embodiment herein; and

FIG. 5 illustrates a graphical representation of degree of a partial filing of a flow of a flow of a fluid through a conduit according to the embodiment herein.

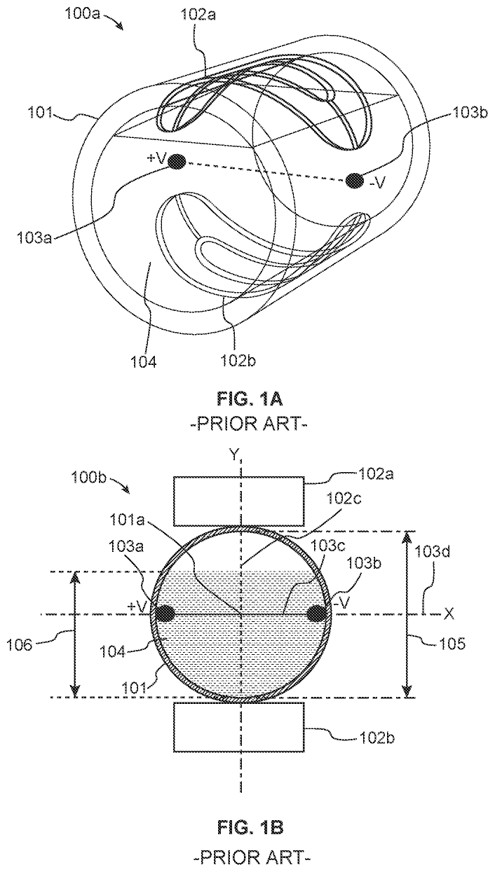

### DETAILED DESCRIPTION OF THE INVENTION

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

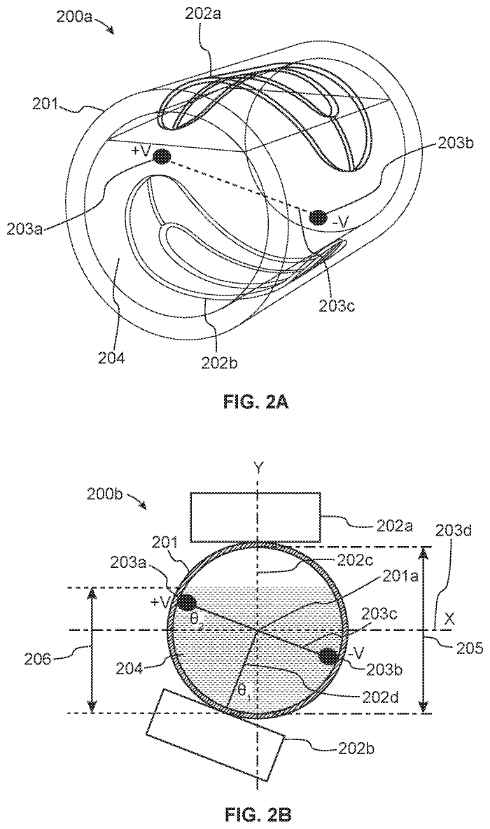

As mentioned above, there is a need for an electromagnetic (EM) flowmeter to detect change in flowrate of a fluid as well as occurrence of partial filing of a conduit with a minimal modification to components of the existing EM flowmeter. The embodiments herein achieve this by providing a minimal modification related to placement of the EM flowmeter components such as coils and electrodes. Referring now to the drawings, and more particularly to FIGS. 2A through 5, where similar reference characters denote corresponding features consistently throughout the figures, there are shown preferred embodiments.

FIG. 2A illustrates a perspective view 200a of an electromagnetic (EM) flowmeter according to an embodiment. The EM flowmeter is provided for measuring a flow of a fluid 204 through a conduit 201. The EM flowmeter comprises at least two coils 202a, 202b and at least two electrodes 203a, 203b. The at least two coils 202a, 202b are arranged on the conduit 201. The at least two coils 202a, 202b are electrically excited to generate a magnetic field within a flowmeter fluid space of the conduit 201. The at least two electrodes 203a, 203b are arranged diametrically opposite to each other to detect an induced voltage in the flowmeter fluid space in response to the generated magnetic field.

FIG. 2B illustrates a cross-sectional view 200b of the EM flowmeter of FIG. 2A according to an embodiment. A first coil 202a of the at least two coils 202a, 202b is placed around a first central axis 202c of the conduit 201 and a second coil 202b of the at least two coils 202a, 202b is placed around a second central axis 202d of the conduit 201. In one embodiment, the second central axis 202d is different from the first central axis 202c. It is to be noted that to create asymmetrical arrangement, the first central axis 202c subtends a first predefined angle θ₁ with the second central axis 202d. The at least two electrodes 203a, 203b are placed at a second predefined angle θ₂. The second predefined angle θ₂ is subtended at a center 201a of the conduit 201 between a central axis 203c passing through the at least two electrodes 203a, 203b, and an axis 203d that is perpendicular to the first central axis 202c of the conduit 201.

According to an embodiment, the at least two coils 202a, 202b and the at least two electrodes 203a, 203b are asymmetric across the first central axis 202c of the EM flowmeter. That is, the second coil 202b of the at least two coils 202a, 202b is subtend with the first predefined angle θ₁ (θ₁ is +/−5%) that is not equal to zero and the at least two electrodes 203a, 203b are placed at the second predefined angle θ₂ (θ₂ is +/−5%) that is not equal to zero. The measured absolute value of a ratio of the induced voltages (+V/−V) may not be ‘1’ for different flow rates of the flow of the fluid 204 through the conduit 201 or for full pipe/conduit condition, due to the above mentioned asymmetry. Especially, under full pipe condition, the absolute value of the ratio of the induced voltages (+V/−V) is an index (p) and that is not equal to ‘1’. Further, under partial flow condition, the index (p) may change, and the change in the index (p) value can be used to estimate the degree of the partial filing. Thus, the degree of the partial filling can be quantified using the EM flowmeter of the present invention.

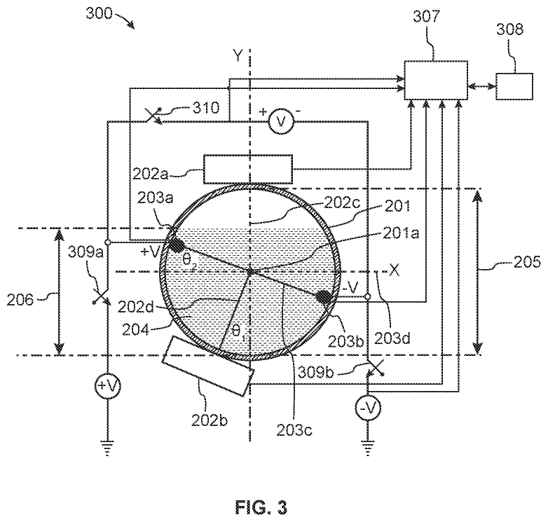

FIG. 3 illustrates an exemplary arrangement of the EM flowmeter 300 according to an embodiment. The EM flowmeter 300 for measuring the flow of the fluid 204 through the conduit 201. The EM flowmeter 300 further comprises a control circuitry 307. In an example embodiment, the control circuitry 307 can be at least one of or in combination but not limited to a switching circuit, a sensing circuit and so on.

According to the embodiment, the control circuitry 307 for measuring the induced voltage on each of the at least two electrodes 203a, 203b to provide a measure of the flow of the fluid 204 through the conduit 201. The flow of the fluid 204 is determined by measuring a potential difference between the at least two electrodes 203a, 203b, by controlling a switch 310. The switch 310 is kept closed while measuring the potential difference between the at least two electrodes 203a, 203b and the switch 309a, 309b is open while measuring the induced voltages of each the at least two electrodes 203a, 203b. In an embodiment, the EM flowmeter 300 works as the conventional flowmeter for measuring the flowrate or velocity of the fluid. However, during a diagnostic cycle (e.g. 5 seconds in a 1 minute interval), induced voltages (+V and −V) are measured to detect and quantify the partial filing of the flow of the fluid 204 through the conduit 201. In one embodiment, a controller or a user or a customer can select length of the diagnostic cycle as a fraction of a total measurement time. The induced voltages can be measured using a means for measuring the voltages. In one embodiment, the means can be but not limited to a sensor, a voltmeter, multi-meter and so on.

According to an embodiment, the induced voltages at electrodes can be individually measured by closing switches 309a, 309b that are connected to the means for measuring the induced voltages and closing switch 310. For example, the control circuitry 307 opens the switch 310 and the switch 309b and closes the switch 309a to connect a first electrode 203a of the at least two electrodes 203a, 203b with a ground thereby to measure the induced voltage +V. Similarly, the control circuitry 307 opens the switch 310 and the switch 309a and closes the switch 309b to connect a second electrode 203b of the at least two electrodes 203a, 203b with a ground thereby to measure the induced voltage −V.

According to an embodiment, the control circuitry 307 comprising a processing unit 308 for determining the degree of the partial filling of the conduit 201 based on the index (p) or at least one ratio between the measured induced voltages of each of the at least two electrodes 203a, 203b by referring to a characteristic curve. The at least one ratio is utilized to estimate the degree of a partial filling of the conduit 201 at different flow rates by referring to the characteristic curve based on its variation from the ratio under fully filled condition. According to an embodiment, the index (p) is constant for the EM flowmeter 300 at all flowrates, for a fully filled conduit. The degree of the partial filling of the conduit 201 is directly proportional to the index (p) and the relation between the degree of the partial filling. The index (p) is given below in equation 1. Further, the relation between the index (p) and the measured induced voltages of each of the at least two electrodes 203a, 203b is given below in equation 2. Using this relationship, a percentage of the partial filing can be detected and quantified.

$$Index ( p ) ∝ degree of filling ( in percentage ) \qquad Equation 1$$

$$Index ( p ) = \vert \frac{+ Induced voltage at one of the two electrodes}{- Induced voltage at another of the two electrodes} \vert = \vert \frac{+ V}{- V} \vert \qquad Equation 2$$

According to the embodiment, the at least one ratio is the absolute value of the measured induced voltages of each of the at least two electrodes 203a, 203b. The absolute value of the at least one ratio under fully filled condition at the different flowrates, is predetermined for the EM flowmeter 300. The degree of the partial filling of the conduit 201 is a ratio of a height (L) 206 of a fluid surface from bottom of the conduit 201 to a diameter (D) 205 of the conduit 201. The relation between the degree of the partial filling of the conduit 201 and the height (L) 206 of the fluid surface above bottom of the conduit 201 and the diameter (D) 205 of the conduit 201 is given below as shown in equation 3.

$$Degree of partial filling = \frac{L}{D} \qquad Equation 3$$

According to an embodiment, if a fluid level or the height (L) 206 of the fluid surface from bottom of the conduit 201 reduces below the first electrode 203a, then the first electrode 203a may detect a zero voltage. Consequently, the partial flow is estimated by the detected induced voltage in the second electrode 203b. Hence, the partial filing less than 50% of the pipe diameter can also be detected by the EM flowmeter 300. If both the electrodes 203a, 203b detects zero voltages, then the flow of the fluid 204 is assumed to be at a standstill. According to an embodiment, the absolute value of the at least one ratio, p under fully filled condition at the different flowrates is predetermined using a physics-based digital twin model of the given EM flowmeter 300.

According to an embodiment, the physics-based digital twin model of the EM flowmeter 300 is utilized for optimizing the first predefined angle θ₁ of the second coil 202b of the at least two coils 202a, 202b. The first predefined angle this in the range of ±5% subtended from the first central axis 202c. In an example embodiment, when the first predefined angle this zero, the second predefined angle θ₂ is not equal to zero. For example, the second coil 202b is kept diametrically opposite to the first coil 202a of the at least two coils 202a, 202b, and the at least two electrodes 203a, 203b, are kept at the second predefined angle θ₂ that is greater than zero.

According to an embodiment, the physics-based digital twin model of the EM flowmeter 300 is utilized for optimizing the second predefined angle θ₂ of the at least one of the at least two electrodes 203a, 203b. The second predefined angle θ₂ is in a range of ±5% from the axis 203d. According to another embodiment, when the second predefined angle θ₂ is zero, the first predefined angle θ₁ is not equal to zero. For example, the at least two electrodes 203a, 203b are arranged diametrically opposite to each other and perpendicular to the first central axis and the second coil 202b of the at least two coils 202a, 202b is kept in the second central axis at the first predefined angle θ₁ that is greater than zero. The characteristic curve is generated based on the physics-based digital twin model of the EM flowmeter 300 corresponding to the optimized first and second predefined angles (01 and 02).

According to an embodiment, the processing unit 308 is provided for checking the partial filling of the flow of the fluid 204 through the conduit 201 at a predetermined interval. According to an embodiment, the processing unit 308 is provided for sending an alert to a controller/user when the partial filling of the flow of the fluid 204 through the conduit 201 is determined below a predefined threshold.

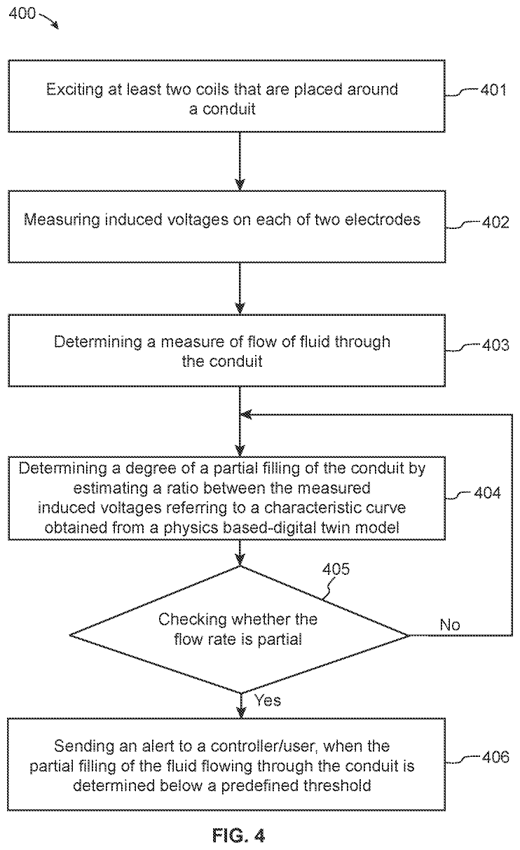

FIG. 4 is a flow diagram illustrating a method 400 for measuring the flow of the fluid 204 through the conduit 201 using the EM flowmeter 300 according to an embodiment. The method is illustrated as a collection of operations in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be deleted from the methods without departing from the scope of the subject matter described herein. In the context of software, the operations represent computer instructions that, when executed by one or more processors, perform the recited operations.

The method of operating the EM flowmeter 300 for measuring the flow of the fluid 204 through the conduit 201 comprising the following steps.

At step 401, the at least two coils 202a, 202b are arranged on the conduit 201, and are excited to generate a magnetic field within the flowmeter fluid space of the conduit 201. The first coil 202a of the at least two coils 202a, 202b is placed around the first central axis 202c of the conduit 201 and the second coil 202b of the at least two coils 202a, 202b is placed around the second central axis 202d of the conduit 201. The second central axis 202d is different from the first central axis 202c and the first central axis 202c subtends the first predefined angle θ₁ with the second central axis 202d.

At step 402, an induced voltage is measured on each of the at least two electrodes 203a, 203b and are arranged to detect an induced voltage in the flowmeter fluid space in response to the generated magnetic field. The at least two electrodes 203a, 203b are placed at the second predefined angle θ₂. The second predefined angle θ₂ is subtended at the center 201a of the conduit 201 between the central axis 203c passing through the at least two electrodes 203a, 203b and the axis 203d that is perpendicular to the first central axis 202c of the conduit 201.

At step 403, the flow of the fluid 204 through the conduit 201 is determined by measuring the potential difference across the at least two electrodes 203a, 203b.

At step 404, the degree of the partial filling of the conduit 201 is determined based on at least one ratio, p, between the measured induced voltages of each of the at least two electrodes 203a, 203b. The at least one ratio, p, is ratio of measured induced voltages of each of the at least two electrodes 203a, 203b. The value of the at least one ratio, p under fully filled condition under any flowrate, is predetermined using the physics based digital twin model of the given flowmeter 300. Further, the at least one ratio is utilized to estimate the degree of a partial filling of the conduit 201 at different flow rates by referring to the characteristic curve, based on its variation from the ratio under fully filled condition. The degree of the partial filling of the conduit 201 is the ratio of the height (L) 206 of the fluid surface from bottom of the conduit 201 to the diameter (D) 205 of the conduit 201.

At step 405, the partial filling of the flow of the fluid 204 through the conduit 201 is checked at a predetermined interval, for example, the flow of the fluid 204 through the conduit 201 is monitored periodically at an interval of once in an hour or once in two hours and so on, to keep control over the flow rate of the fluid 204 through the conduit 201. The predetermined interval can be configured through a hardware means such as a microcontroller, a user interface and so on. The method repeats the step 404 to check the partial filling of the flow of the fluid 204 through the conduit 201 at the predetermined interval, if the partial filling of the fluid 204 is not detected.

At step 406, an alert can be sent to a controller/user when the partial filling of the flow of the fluid 204 through the conduit 201 is determined below the predefined threshold. For example, the alert can be an indication or signaling or a further process controlling and so on.

According to the embodiment, the method further comprising a step of optimizing the first predefined angle θ₁ of the second coil 202b of the at least two coils 202a, 202b using the physics-based digital twin model of the EM flowmeter 300. The first predefined angle θ₁ is in the range of ±5% from the first central axis 202c and when the first predefined angle θ₁ is zero, the second predefined angle θ₂ is not equal to zero.

According to an embodiment, the method comprising the step of optimizing the second predefined angle θ₂ of the at least one of the at least two electrodes 203a, 203b using the physics-based digital twin model of the EM flowmeter 300. The second predefined angle θ₂ is in a range of ±5% from the axis 203d and when the second predefined angle θ₂ is zero, the first predefined angle θ₁ is not equal to zero. The characteristic curve is generated based on the physics-based digital twin model of the EM flowmeter 300 corresponding to the optimized first and second predefined angles (θ₁ and θ₂).

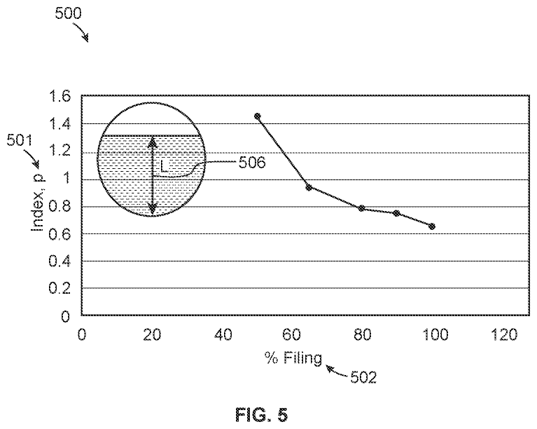

According to an embodiment, the physics-based digital twin model of the given EM flowmeter 300 is used to determine the value of p for fully filled condition. The value of p is independent of flowrate under fully filled condition. The digital twin also generates the characteristic curve (FIG. 5), which relates the ratio p with a percentage filing or degree of the partial filing. Degree of the partial filing or percentage filing is determined on the basis of the measured value of index (p), using the characteristic curve in FIG. 5. The model works on finite element analysis and solves relevant physics-based equations to simulate functioning of the EM flowmeter 300. The model can be simulated for various degrees of the partial filing of the conduit 201. The degree of the partial filing can be given by the ratio of height (L) 206 of the fluid surface above the bottom of the conduit 201 to the diameter (D) 205 of the conduit 201, expressed as a percentage. At each partial filing situation, the measured induced voltages +V and −V (described in FIG. 3) can be estimated to detect the partial filling of the conduit 201.

FIG. 5 illustrates a graphical representation 500 of the degree of the partial filing of the flow of the fluid 204 through the conduit 201 according to an embodiment. The graphical representation 500 illustrates the degree of the partial filling of the flow of the fluid 204 through the conduit 201 in percentage versus the index (p) estimated based on the induced voltages that are sensed at the at least two electrodes 203a, 203b. The absolute value of the ratio of the induced voltages (+V, −V) of the at least two electrodes 203a, 203b or the index (p) 501 can be calculated using the physics-based digital twin model of the EM flowmeter 300 as mentioned above. and plotted as a function of percentage partial filing 502. It can be seen that, the value of the index (p) is 0.65 for the embodiment described in the present invention and not ‘1’ when the conduit 201 is full. The value of the index (p) can be significantly changed under different partial filling conditions of the conduit 201 by various degrees. Further, a unique relationship is identified between the index (p) and the percentage partial filing 502, as shown in equation 4 below:

$$Index ( p ) = \vert \frac{+ Induced voltage at one of the two electrodes}{- Induced voltage at another of the two electrodes} \vert = \vert \frac{+ V}{- V} \vert \qquad Equation 4$$

According to the embodiment, the modeling study can indicate that the tilted coil and electrode-to-electrode line, along with, individual measurement of extreme end voltages, can be successful in detecting and quantifying partial filing effect. According to the embodiment, the EM flowmeter 300 can have the capability to quantify partial filing below 50%. When the fluid level drops below the second electrode 203b, the voltage measured at the first electrode 203a can be used to estimate the partial filing.

An advantage of the above mentioned the EM flowmeter 300 is to measure a flowrate of the fluid 204 as well as the partial filing of the conduit 201 with a minimal modification of its components. This improves overall system performance. The detection and quantification of the partial filling enhances a flow system performance by increasing a reliability and the EM flowmeter 300 avoids usage of expensive and invasive sensors.

The foregoing description of the specific embodiments will so fully reveal the general nature of the embodiments herein that a person skilled in the art can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electromagnetic (EM) flowmeter for measuring a flow of a fluid through a conduit, comprising:
at least two coils arranged on the conduit, wherein the at least two coils are electrically excited to generate a magnetic field within a flowmeter fluid space of the conduit; wherein a first coil of the at least two coils is placed around a first central axis of the conduit and a second coil of the at least two coils is placed around a second central axis of the conduit, wherein the second central axis is different from the first central axis and the first central axis subtends a first predefined angle θ₁ with the second central axis,
at least two electrodes arranged diametrically opposite to each other to detect an induced voltage in the flowmeter fluid space in response to the generated magnetic field; wherein the at least two electrodes are placed at a second predefined angle θ₂, wherein the second predefined angle θ₂ is subtended at a center of the conduit between a central axis passing through the at least two electrodes and an axis that is perpendicular to the first central axis of the conduit; and
a control circuitry for measuring the induced voltage on each of the at least two electrodes to provide a measure of the flow of the fluid through the conduit.

2. The EM flowmeter as claimed in claim 1, wherein the control circuitry comprises a processing unit for determining a degree of a partial filling of the conduit based on at least one ratio between the measured induced voltages of each of the at least two electrodes; wherein the at least one ratio is utilized to estimate the degree of a partial filling of the conduit at different flow rates, by referring to a characteristic curve; wherein the characteristics curve is generated using a physics-based digital twin model of the EM flowmeter.

3. The EM flowmeter as claimed in claim 2, wherein the at least one ratio is an absolute value of the measured induced voltages of each of the at least two electrodes; and wherein the degree of the partial filling of the conduit is a ratio of a height of a fluid surface from bottom of the conduit to a diameter of the conduit.

4. The EM flowmeter as claimed in claim 3, wherein the absolute value of the at least one ratio under fully filled condition at a different flowrates, is predetermined by the physics-based digital twin model of the EM flowmeter.

5. The EM flowmeter as claimed in claim 4, wherein the physics-based digital twin model of the EM flowmeter is utilized for optimizing the first predefined angle θ₁ of the second coil of the at least two coils; wherein the first predefined angle this in the range of ±5% from the first central axis; and wherein when the first predefined angle this zero, the second predefined angle θ₂ is not equal to zero.

6. The EM flowmeter as claimed in claim 4, wherein the physics-based digital twin model of the EM flowmeter is utilized for optimizing the second predefined angle θ₂ of the at least one of the at least two electrodes; wherein the second predefined angle θ₂ is in a range of ±5% from the axis; and wherein when the second predefined angle θ₂ is zero, the first predefined angle θ₁ is not equal to zero.

7. The EM flowmeter as claimed in claim 2, wherein the processing unit for checking the partial filling of the flow of the fluid through the conduit at a predetermined interval.

8. The EM flowmeter as claimed in claim 2, wherein the processing unit for sending an alert to a controller or user, when the partial filling of the flow of the fluid through the conduit is determined below a predefined threshold.

9. A method of operating an electromagnetic (EM) flowmeter for measuring a flow of a fluid through a conduit, the method comprising:
exciting at least two coils that are arranged on the conduit to generate a magnetic field within a flowmeter fluid space of the conduit; wherein a first coil of the at least two coils is placed around a first central axis of the conduit and a second coil of the at least two coils is placed around a second central axis of the conduit, wherein the second central axis is different from the first central axis and the first central axis subtends a first predefined angle θ₁ with the second central axis; and
measuring an induced voltage on each of at least two electrodes that are arranged to detect an induced voltage in the flowmeter fluid space in response to the generated magnetic field, wherein the at least two electrodes are placed at a second predefined angle θ₂, wherein the second predefined angle θ₂ is subtended at the center of the conduit between a central axis passing through the at least two electrodes and an axis that is perpendicular to the first central axis of the conduit.

10. The method as claimed in claim 9, further comprising determining a degree of a partial filling of the conduit based on at least one ratio between the measured induced voltages of each of the at least two electrodes by referring to a characteristic curve, wherein the characteristic curve is generated using a physics based digital twin model of the EM flowmeter.

11. The method as claimed in claim 10, wherein the at least one ratio is an absolute value of the measured induced voltages of each of the at least two electrodes; and wherein the degree of the partial filling of the conduit is a ratio of a height of a fluid surface from bottom of the conduit to a diameter of the conduit.

12. The method as claimed in claim 11, wherein the absolute value of the at least one ratio under fully filled condition at a different flowrates is predetermined by the physics based digital twin model of the EM flowmeter.

13. The method as claimed in claim 12, further comprising optimizing the first predefined angle θ₁ of the second coil of the at least two coils using the physics based digital twin model; wherein the first predefined angle this in the range of ±5% from the first central axis; and wherein when the first predefined angle this zero, the second predefined angle θ₂ is not equal to zero.

14. The method as claimed in claim 12, further comprising optimizing the second predefined angle θ₂ of the at least one of the at least two electrodes using the physics based digital twin model; wherein the second predefined angle θ₂ is in a range of ±5% from the axis; and wherein when the second predefined angle θ₂ is zero, the first predefined angle θ₁ is not equal to zero.

15. The method as claimed in claim 10, further comprising checking the partial filling of the flow of the fluid through the conduit at a predetermined interval.

16. The method as claimed in claim 10, further comprising sending an alert to a controller or user, when the partial filling of the flow of the fluid through the conduit is determined below a predefined threshold.
